(19) United States
(12) Patent Application Publication
(10) Pub. No.: US 2026/0133415 A1
(43) Pub. Date: May 14, 2026

(54) OPTICAL NAVIGATION DEVICE

(71) Applicant: PixArt Imaging Inc., Hsin-Chu City (TW)

(72) Inventors: Yee Loong CHIN, Penang (MY); Beng Huat Low, Penang (MY); Hun Kwang Lee, Penang (MY); Sai Mun Lee, Penang (MY)

(73) Assignee: PixArt Imaging Inc., Hsin-Chu City (TW)

(21) Appl. No.: 18/946,858

(22) Filed: Nov. 13, 2024

(51) Int. Cl. G02B 26/08

(52) U.S. Cl. CPC G02B 26/0875

(57) ABSTRACT

An optical navigation device of analyzing an illumination beam reflected from a navigation surface to execute navigation operation is disclosed. The optical navigation device includes an illumination light source, an illumination lens and a moving mechanism. The illumination light source is used to emit the illumination beam. The illumination lens is disposed adjacent to the illumination light source and located on an output path of the illumination beam. The moving mechanism is connected to the illumination lens and adapted to drive a relative movement between the illumination lens and the illumination light source, so as to adjust a projection position of the illumination beam passing through the illumination lens and further to keep the navigation surface within a working range of the optical navigation device.

### BACKGROUND OF THE INVENTION

### 1. Field of the Invention

The present invention relates to an optical navigation device, and more particularly, to an optical navigation device capable of adjusting the working range, the illumination beam angle and/or the cut-off height.

### 2. Description of the Prior Art

A conventional optical navigation device includes an illumination channel of emitting an illumination beam, and an imaging channel of detecting a reflection beam from a navigation surface. The navigation surface is a flat surface made of various materials, such as metal, glass, fabric, printed objects, and painted objects. The reflection beam intercepted beyond the imaging channel is not received by an optical detector of the optical navigation device, which sets the near-end limit and the far-end limit for the working distance of the optical navigation device. An interval between the near-end limit and the far-end limit is defined as a depth of field of the optical navigation device. All the elements of the conventional optical navigation device are fixed at specific positions without any movable parts, and the working distance of the conventional optical navigation device is fixed accordingly. Therefore, design of an optical navigation device capable of adjusting its working distance of the depth of field is an important issue in the related optical apparatus industry.

### SUMMARY OF THE INVENTION

The present invention provides an optical navigation device capable of adjusting the working range, the illumination beam angle and/or the cut-off height for solving above drawbacks.

According to the claimed invention, an optical navigation device of analyzing an illumination beam reflected from a navigation surface to execute navigation operation is disclosed. The optical navigation device includes an illumination light source, an illumination lens and a moving mechanism. The illumination light source is used to emit the illumination beam. The illumination lens is disposed adjacent to the illumination light source and located on an output path of the illumination beam. The moving mechanism is connected to the illumination lens and adapted to drive a relative movement between the illumination lens and the illumination light source, so as to adjust a projection position of the illumination beam passing through the illumination lens and further to keep the navigation surface within a working range of the optical navigation device.

According to the claimed invention, the optical navigation device further includes a case adapted to accommodate the illumination light source, the illumination lens and the moving mechanism, the moving mechanism includes an adjustment component movably passing through the case and abutting against the illumination lens to generate the relative movement. The adjustment component is moved relative to the case in a manual manner or in an automatic manner.

According to the claimed invention, the moving mechanism further includes a recovery component disposed adjacent to the illumination lens and adapted to move the illumination lens back to an initial position. The optical navigation device further includes a connection component disposed on the case and attached to the adjustment component, and adapted to drive the adjustment component for the relative movement. The moving mechanism further includes a guide track where inside the illumination lens is movably disposed, and the guide track is adapted to constrain a moving direction of the illumination lens.

According to the claimed invention, the recovery component is a compression spring or a tension spring disposed between the illumination lens and an imaging lens of the optical navigation device, or disposed between the illumination lens and the case. The recovery component is a magnetic assembly, and two magnetic components of the magnetic assembly are respectively disposed on the illumination lens and an imaging lens of the optical navigation device, or respectively disposed on the illumination lens and the case. Two opposite ends of the recovery component are respectively connected to the illumination lens and an imaging lens of the optical navigation device, or are integrated with the illumination lens and the imaging lens monolithically.

According to the claimed invention, the optical navigation device further includes an optical detector adapted to receive the illumination beam reflected from the navigation surface for the navigation operation. An imaging channel provided by the optical detector is perpendicular to the navigation surface, or a predefined included angle is formed between the imaging channel and the navigation surface.

According to the claimed invention, the optical navigation device further includes an imaging lens disposed adjacent to the illumination lens and aligning with the optical detector. The imaging lens and the illumination lens are two independent units, or are monolithically integrated with each other. A moving direction of the illumination lens is perpendicular to an output optical axis of the illumination light source.

The optical navigation device of the present invention can provide several embodiments having the tunable working range (or the tunable DOF), the tunable illumination beam angle and/or the tunable cut-off height, and can benefit applications which require the optical detectors to be tunable for different angles of incidence in response to different types of the navigation surfaces (i.e. surfaces with different roughness or reflectivity) despite of no change in the working DOF. The optical navigation device can include the illumination light source used to provide the illumination beam, the illumination lens used to shape the illumination beam, the optical detector having the vertical imaging channel to detect diffuse reflection from the navigation surface, and the imaging lens located on the imaging channel. Position of the illumination lens can be manually adjusted by the user, or can be automatically adjusted by the motorized knob, for changing the beam tilted angle of the illumination beam relative to the navigation surface, and achieve an aim of adjusting or tuning the working range (and/or DOF), the tunable illumination beam angle and/or the tunable cut-off height. The illumination lens can be designed as an optical element separated from the imaging lens, and can be connected with the imaging lens via the mechanical recovery component; or, the illumination lens may be integrated with the imaging lens monolithically via the molded recovery component. Therefore, the optical navigation device can utilize the moving mechanism to change the position of the illumination lens, so as to adjust the projection position of the illumination beam passing through the illumination lens and the related beam tilted angle, and further to provide the tunable DOF for keeping the navigation surface within the working range of the optical navigation device, and/or to provide the tunable cut-off height for a variety of the optical navigation device. The optical navigation device of the present invention can be preferably applied to the embodiment of requesting the optical detector to be tunable for different angles of incidence (or the beam tilted angle) when being applied for different types of the navigation surface having different roughness or reflectivity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are diagrams of an optical navigation device in different operation modes according to a first embodiment of the present invention.

FIG. 3 is a diagram of the optical navigation device in another type according to the first embodiment of the present invention.

FIG. 4 is a diagram of the optical navigation device according to a second embodiment of the present invention.

FIG. 5 is a diagram of the optical navigation device according to a third embodiment of the present invention.

FIG. 6 is a diagram of the optical navigation device according to a fourth embodiment of the present invention.

FIG. 7 is a diagram of the optical navigation device according to a fifth embodiment of the present invention.

FIG. 8 is a diagram of the optical navigation device according to a sixth embodiment of the present invention.

FIG. 9 and FIG. 10 are diagrams of the optical navigation device in other application according to a seventh embodiment of the present invention.

### DETAILED DESCRIPTION

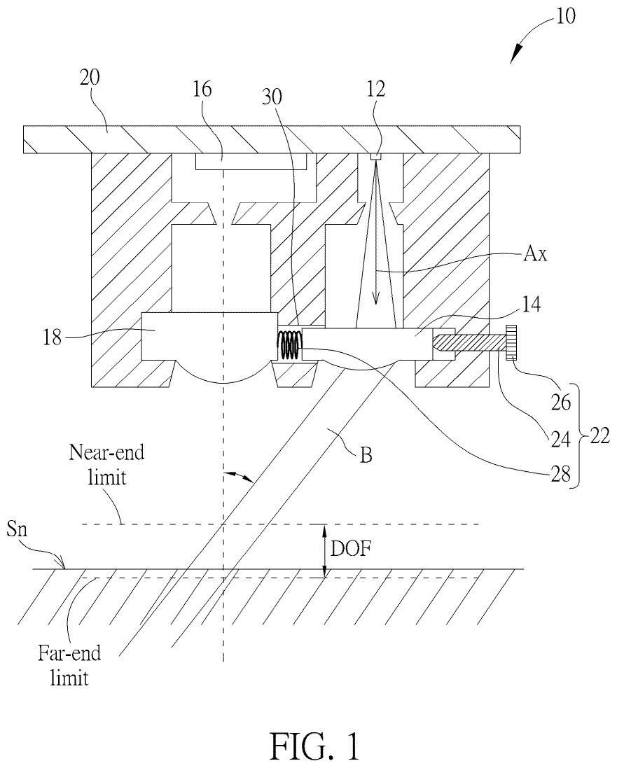

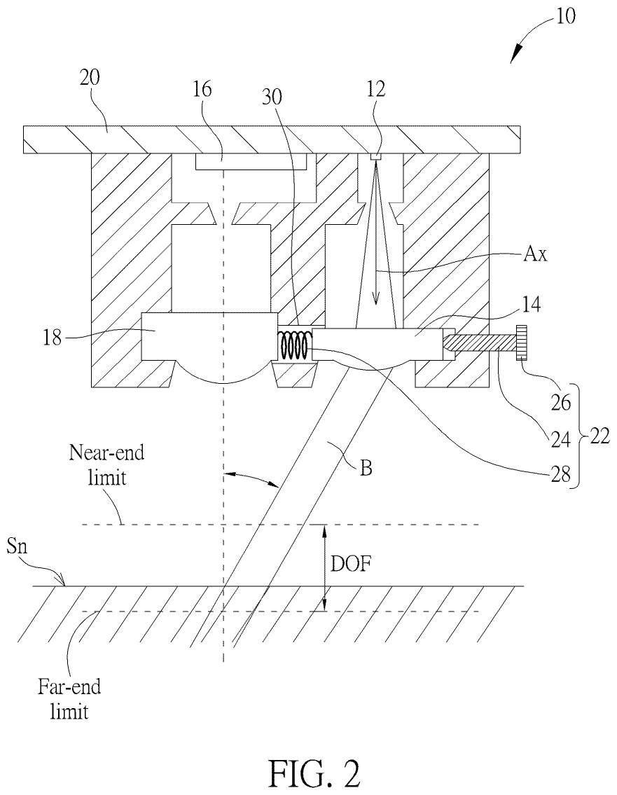

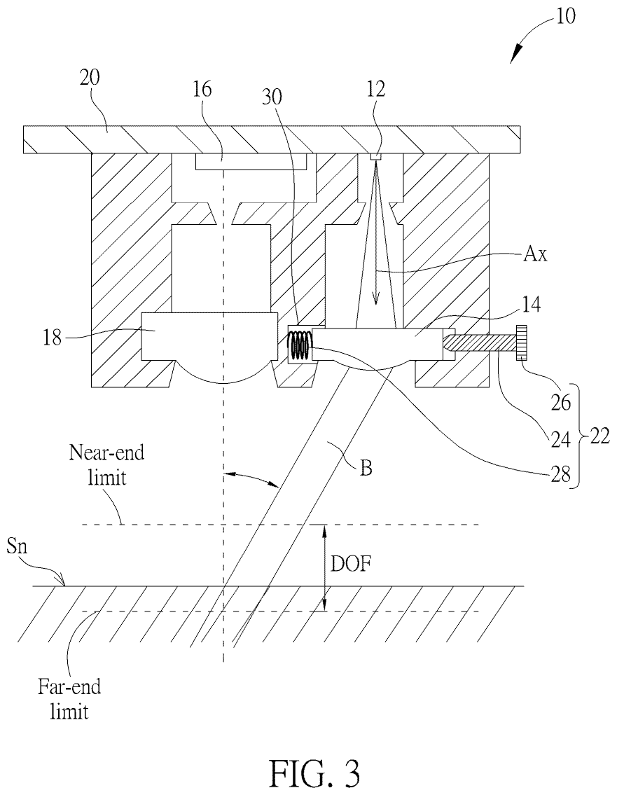

Please refer to FIG. 1 to FIG. 3. FIG. 1 and FIG. 2 are diagrams of an optical navigation device 10 in different operation modes according to a first embodiment of the present invention. FIG. 3 is a diagram of the optical navigation device 10 in another type according to the first embodiment of the present invention. The optical navigation device 10 can be a mouse, or any electronic apparatus with an optical navigation function, which can be moved on or above a navigation surface Sn for navigation operation. The optical navigation device 10 can include an illumination light source 12, an illumination lens 14, an optical detector 16, an imaging lens 18, a case 20 and a moving mechanism 22. The illumination light source 12 can emit an illumination beam B. The illumination lens 14 can be disposed adjacent to the illumination light source 12, and located on an output path of the illumination beam B (which means the illumination beam B can pass through the illumination lens 14). The optical detector 16 can receive the illumination beam B reflected from the navigation surface Sn. The imaging lens 18 can be disposed adjacent to the illumination lens 14 and align with the optical detector 16, so that the illumination beam B reflected from the navigation surface Sn can pass through the imaging lens 18 to be received by the optical detector 16.

The case 20 can accommodate the illumination light source 12, the illumination lens 14, the optical detector 16 and the imaging lens 18, for providing the waterproof and dustproof function. The moving mechanism 22 can be installed on the case 20; some part of the moving mechanism 22 can insert into the case 20 and be connected with the illumination lens 14, and used to drive a relative movement between the illumination lens 14 and the illumination light source 12, so as to adjust a projection position of the illumination beam B passing through the illumination lens 14, and keep the navigation surface Sn within a working range of a depth of field (DOF) of the optical navigation device 10. Other part of the moving mechanism 22 can be disposed outside the case 20, and may be manually operated by the user or automatically operated by a motor to change the relative movement between the illumination lens 14 and the illumination light source 12.

The moving mechanism 22 can include an adjustment component 24, a connection component 26 and a recovery component 28. The adjustment component 24 can be a shaft or any similar structures, which can pierce through the case 20 and abut against the illumination lens 14 for driving the relative movement between the illumination lens 14 and the illumination light source 12. The connection component 26 can be located outside the case 20 and attached to the adjustment component 24. The connection component 26 can be controlled by the user to drive the relative movement between the illumination lens 14 and the illumination light source 12 via the adjustment component 24. For example, assembly of the adjustment component 24 and the connection component 26 can be a bolt or a tuning knob with the similar function, which depends on the design demand. In addition, the user can manually operate the connection component 26 and the adjustment component 24 to move the illumination lens 14, or an electronic motor can be used to automatically actuate the connection component 26 and the adjustment component 24 for moving the illumination lens 14.

The recovery component 28 can be disposed on a side of the illumination lens 14 opposite to the adjustment component 24, and used to move the illumination lens 14 back to an initial position; in other possible situation, the recovery component 28 may be disposed on the same side of the illumination lens 14 as the adjustment component 24. The recovery component 28 can be optionally disposed between the illumination lens 14 and the imaging lens 18, as the first embodiment shown in FIG. 1 and FIG. 2; in the meantime, two opposite ends of the recovery component 28 can be respectively connected with the illumination lens 14 and the imaging lens 18, and therefore the illumination lens 14 and the imaging lens 18 can be two independent units. Besides, the recovery component 28 may be optionally disposed between the illumination lens 14 and the case 20, as the embodiment shown in FIG. 3, and the two opposite ends of the recovery component 28 can be connected with or abut against the illumination lens 14 and the case 20 respectively. The recovery component 28 can be designed as a compression spring or a tension spring. As shown in FIG. 1 to FIG. 3, the recovery component 28 can be set as the compression spring; when the adjustment component 24 moves the illumination lens 14 to the left side, the recovery component 28 is compressed to store a resilient recovering force; when a force of the adjustment component 24 applied to the illumination lens 14 is removed, the resilient recovering force of the recovery component 28 can be released to move the illumination lens 14 to the right side so as to move back to the initial position.

It should be mentioned that the moving mechanism 22 can optionally include a guide track 30 disposed inside the case 20 and on position corresponding to the illumination lens 14. The guide track 30 can be an additional metal track or an additional plastic track, or can be a chamber or a slot caved in the case 20. The illumination lens 14 can be disposed on the guide track 30 in a movable manner, and used to constrain a moving direction of the illumination lens 14 when the moving mechanism 22 moves the illumination lens 14 to the left side or the right side, so as to effectively increase displacement accuracy of the illumination lens 14, and further to prevent navigation accuracy of the optical navigation device 10 from being affected by unexpected shift of the illumination lens 14.

In the first embodiment of the present invention, position of the illumination light source 12 is fixed, and the moving mechanism 22 can be used to horizontally move the illumination lens 14, and therefore the illumination beam B of the illumination light source 12 can be projected onto the navigation surface Sn at different angles, for providing different working ranges (or DOF). The horizontal movement of the illumination lens 14 can be interpreted as the moving direction of the illumination lens 14 is substantially perpendicular to an output optical axis Ax of the illumination light source 12. In order to ensure that the illumination lens 14 does not produce an unwanted movement, the optical navigation device 10 can utilize the guide track 30 or any possible elements to control the moving direction of the illumination lens 14.

As shown in FIG. 1, the moving mechanism 22 can move the illumination lens 14 to the left side, the recovery component 28 can be compressed, and the illumination lens 14 can be moved to the position closest to the imaging lens 18, so that the illumination beam B can have the largest beam tilted angle, and the DOF range can be closest towards the imaging lens 18. As shown in FIG. 2, when the force of the moving mechanism 22 applied to the illumination lens 14 is removed, the resilient recovering force of the recovery component 28 can be released to move the illumination lens 14 to the right side, and the illumination lens 14 can be furthest away from the imaging lens 18, so that the illumination beam B can have the smallest beam tilted angle, and the DOF range can be furthest away from the imaging lens 18.

Moreover, the optical detector 16 and the imaging lens 18 of the optical navigation device 10 can preferably have the vertical imaging channel, which means the imaging channel of the optical detector 16 can be substantially perpendicular to the navigation surface Sn, or be substantially parallel to a planar normal vector of the navigation surface Sn. The present invention allows the vertical imaging channel and the illumination beam B to form a longer interception path or DOF via the above-mentioned design; however, practical application of the imaging channel is not limited to the foresaid embodiment. For example, a predefined included angle may be formed between the imaging channel of the optical detector 16 and the navigation surface Sn, which means the optical detector 16 can have the slanted imaging channel.

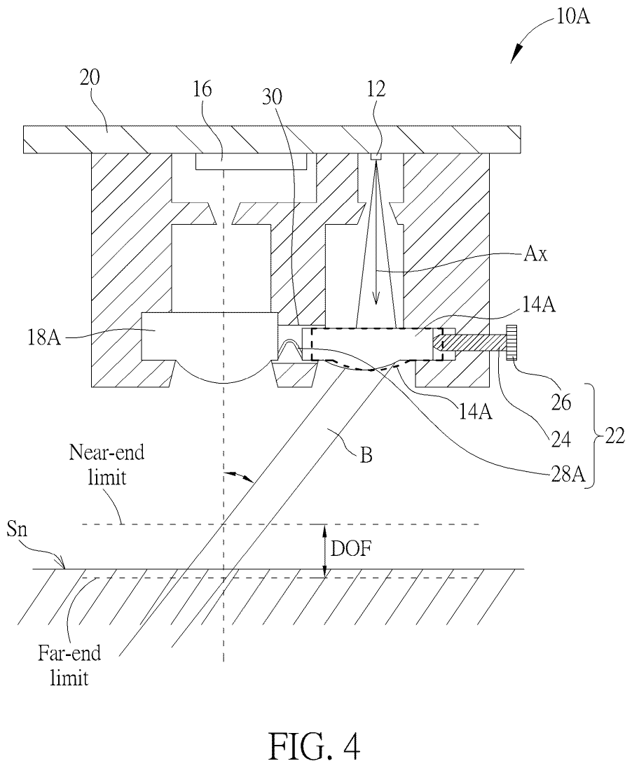

Please refer to FIG. 4. FIG. 4 is a diagram of the optical navigation device 10A according to a second embodiment of the present invention. In the second embodiment, elements having the same numerals as ones of the first embodiment can have the same structures and functions, and a detailed description is omitted herein for simplicity. The recovery component 28A of the optical navigation device 10A can be integrated with the illumination lens 14A and the imaging lens 18A monolithically. A number of components of the optical navigation device 10A can be reduced by integration of the illumination lens 14A, the recovery component 28A and the imaging lens 18A, which is beneficial to increasing the production speed and assembly yield of the manufacturing process. Besides, the illumination lens 14A, the recovery component 28A and the imaging lens 18A can be preferably manufactured by flexible material, and the foresaid integration can be adaptively deformed in the installation process and the usage process so as to cooperate with spatial configuration within the case 20 and operation of the moving mechanism 22.

It should be mentioned that although the illumination lens 14A and the imaging lens 18A are an integrally formed element, the moving mechanism 22 can still move the illumination lens 14A to the left side or the right side independently; the illumination beam B of the illumination light source 12 can pass through different positions on the illumination lens 14A to provide different beam tilted angles and then generate different DOFs. For example, when the illumination lens 14A is moved to the left side (such as the solid line pattern), the illumination beam B can have the largest beam tilted angle; when the illumination lens 14A is moved to the right side (such as the dashed line pattern), the illumination beam B can have the smallest beam tilted angle.

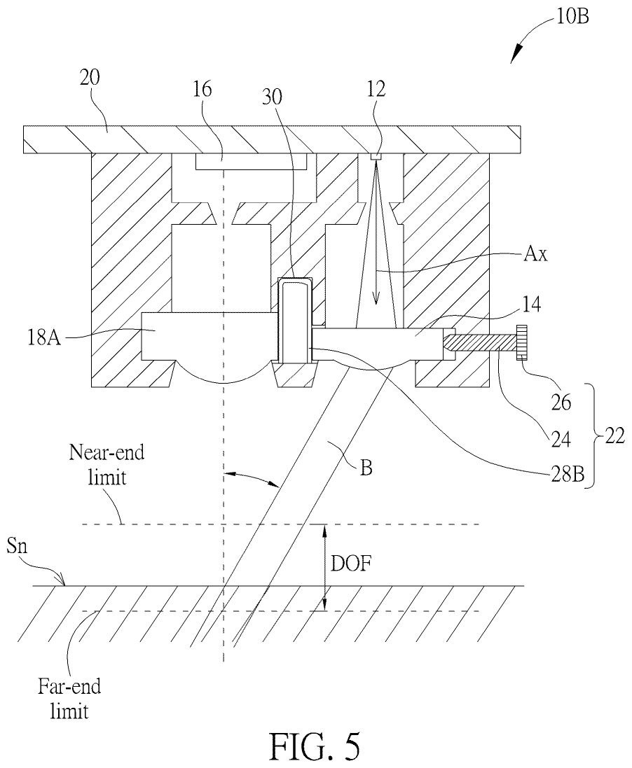

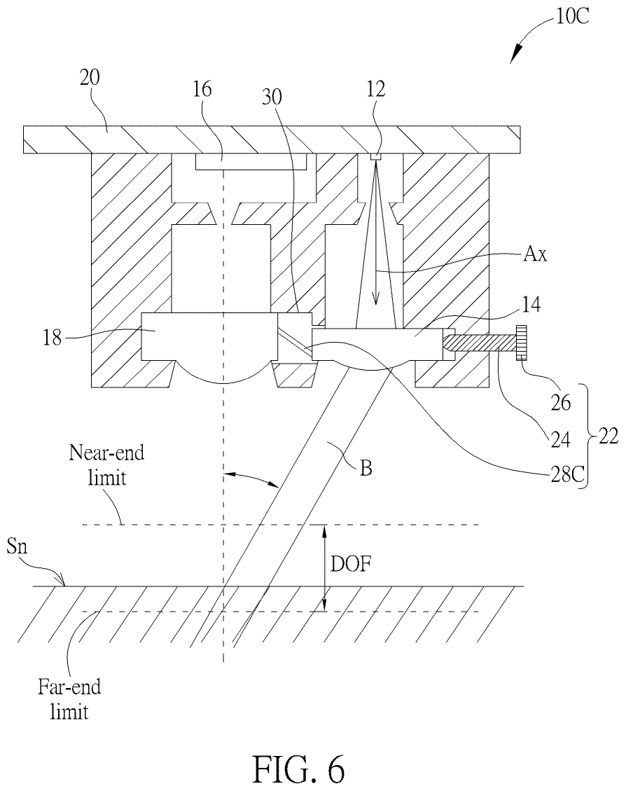

Please refer to FIG. 5 and FIG. 6. FIG. 5 is a diagram of the optical navigation device 10B according to a third embodiment of the present invention. FIG. 6 is a diagram of the optical navigation device 10C according to a fourth embodiment of the present invention. In the third and fourth embodiments, elements having the same numerals as ones of the foresaid embodiments can have the same structures and functions, and the detailed description is omitted herein for simplicity. The third and fourth embodiments can have the molded spring design different from the foresaid embodiments. As shown in FIG. 5, the recovery component 28B of the optical navigation device 10B can be designed as an elongated U-shaped spring, which can allow higher strain and provide preferred reliability to avoid the recovery component 28B from breakage against frequent tuning. As shown in FIG. 6, the recovery component 28C of the optical navigation device 10C can be designed as a zigzag shape spring; the zigzag shape spring can be a single cross-bar zigzag spring or a series of cross-bars zigzag spring, which depends on inner space of the optical navigation device 10C.

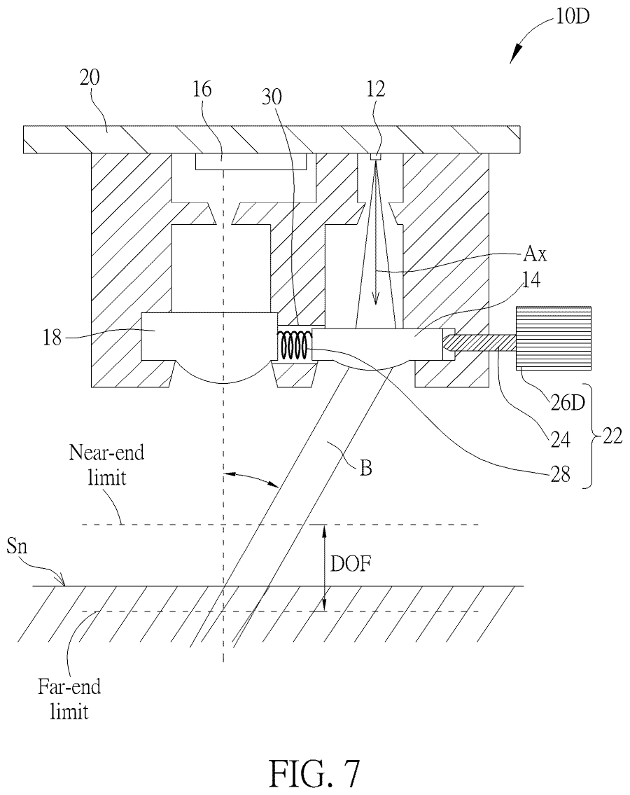

Please refer to FIG. 7. FIG. 7 is a diagram of the optical navigation device 10D according to a fifth embodiment of the present invention. In the fifth embodiment, elements having the same numerals as ones of the foresaid embodiments can have the same structures and functions, and the detailed description is omitted herein for simplicity. The connection component 26D of the optical navigation device 10D can be designed as a motorized knob, which can provide accurate and automatic adjustment. The connection component 26D can include, but not be limited to, a miniature linear electric motor, a DC electric linear actuator, or a piezoelectric motor. The connection component 26D can be applied for the recovery component 28 designed as the compression spring or the tension spring, or can be applied for the moving mechanism 22 of the second embodiment or the third embodiment or the fourth embodiment.

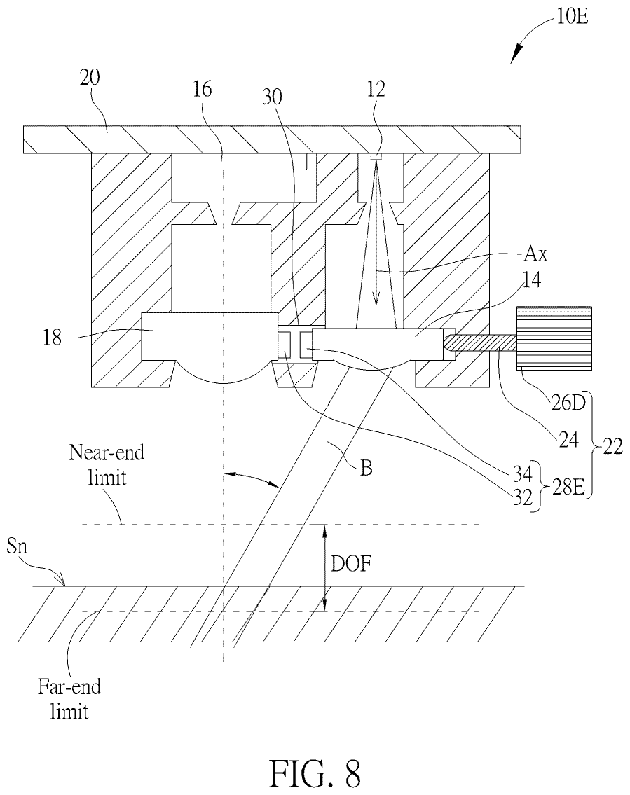

Please refer to FIG. 8. FIG. 8 is a diagram of the optical navigation device 10E according to a sixth embodiment of the present invention. In the sixth embodiment, elements having the same numerals as ones of the foresaid embodiments can have the same structures and functions, and the detailed description is omitted herein for simplicity. The recovery component 28E of the optical navigation device 10E can be magnetic assembly including magnetic components 32 and 34. The magnetic components 32 and 34 can be respectively disposed on the imaging lens 18 and the illumination lens 14 to generate a magnetic repulsion force. When the pushing force applied for the illumination lens 14 to the left side is removed, the magnetic repulsion force of the magnetic components 32 and 34 can move the illumination lens 14 to the right side. In other possible embodiment, the magnetic components 32 and 34 may be optionally disposed on the case 20 and the illumination lens 14 generate the magnetic repulsion force, or may be disposed on other positions to generate a magnetic attraction force for pushing the illumination lens 14 in a desired direction; position of the magnetic components 32 and 34 can depend on the design demand.

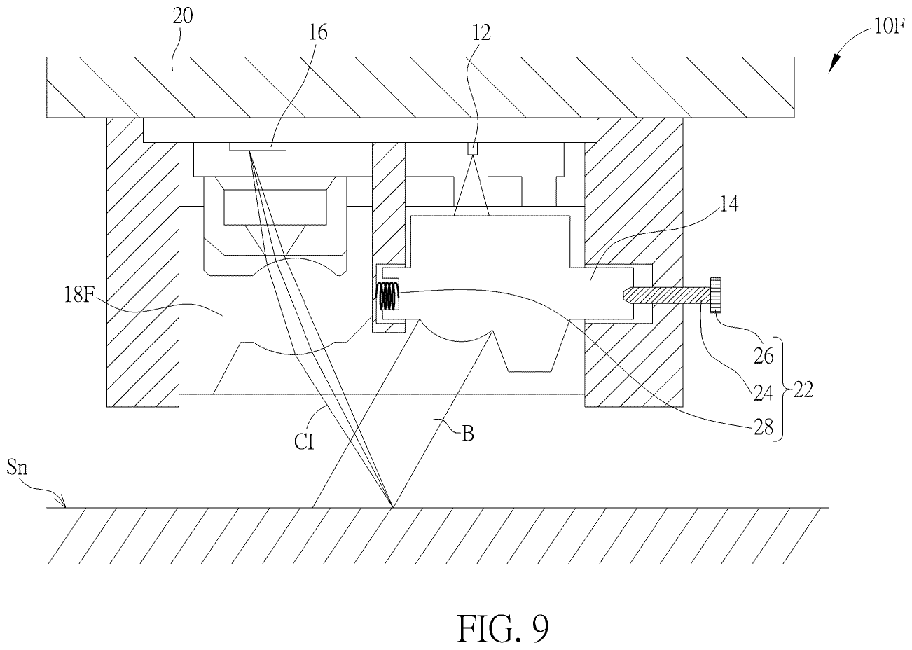

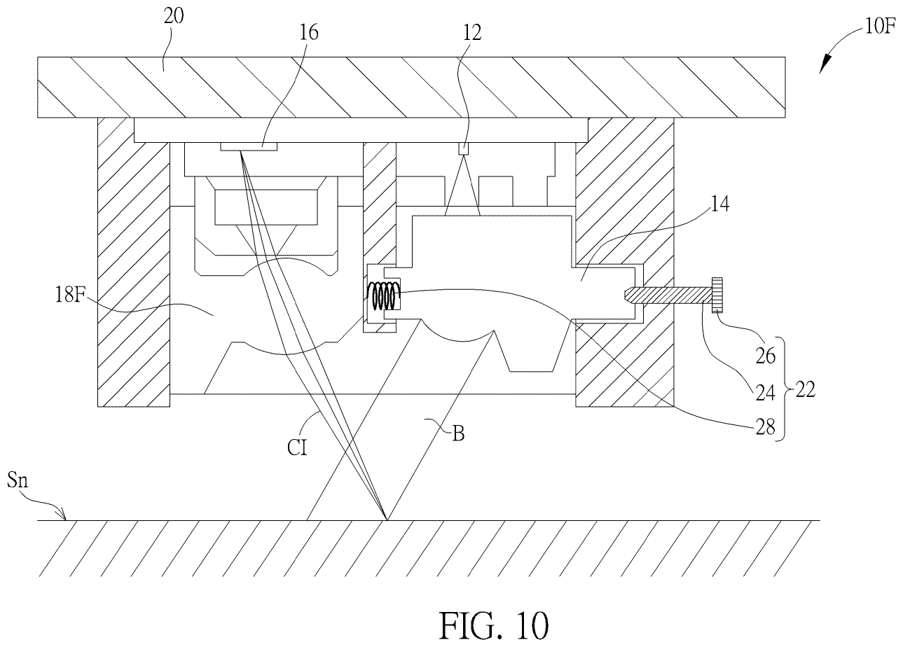

Please refer to FIG. 9 and FIG. 10. FIG. 9 and FIG. 10 are diagrams of the optical navigation device 10F in other application according to a seventh embodiment of the present invention. In the seventh embodiment, elements having the same numerals as ones of the foresaid embodiments can have the same structures and functions, and the detailed description is omitted herein for simplicity. The illumination lens 14 of the optical navigation device 10F can be independent from the imaging lens 18F, and the moving mechanism 22 can move the illumination lens 14 to the right or to the left, so the illumination beam B can be moved on the navigation surface Sn accordingly in the same direction. Because a cut-off height (or can be interpreted as a lift height for the cut-off) of the optical navigation device 10F is associated with an edge position of the illumination beam B for relative change, the moving mechanism 22 can drive the relative movement of the illumination lens 14 to alter the cut-off height of the optical navigation device 10F by changing the edge position of the illumination beam B. An imaging channel CI of the optical detector 16 is not limited to the slanted imaging channel in FIG. 9 and FIG. 10, and can be set as the vertical imaging channel shown in other figures.

As shown in FIG. 9, when the moving mechanism 22 moves the illumination lens 14 to a position closest to the imaging lens 18F, the edge position of the illumination beam B can move towards the imaging lens 18F, and the optical navigation device 10F can have the lower cut-off height due to geometry between the illumination beam B and the imaging channel (or a field of view of the optical detector 16). As shown in FIG. 10, when the moving mechanism 22 moves the illumination lens 14 to a position away from the imaging lens 18F, the edge position of the illumination beam B can move away from the imaging lens 18F, and the optical navigation device 10F can provide the higher cut-off height due to the geometry between the illumination beam B and the imaging channel of the optical detector 16. In addition, altering operation of the cut-off height can be optionally applied for the second embodiment (which has the recovery component 28A monolithically integrated between the illumination lens 14A and the imaging lens 18A), the third embodiment and the fourth embodiment (which includes the recovery components 28B and 28C with specific shapes), the fifth embodiment (which includes the motorized knob for automatically tuning), and the sixth embodiment (which uses the magnetic components 32 and 34 as the recovery component 28E).

In conclusion, the optical navigation device of the present invention can provide several embodiments having the tunable working range (or the tunable DOF), the illumination beam angle and/or the tunable cut-off height, and can benefit applications which require the optical detectors to be tunable for different angles of incidence in response to different types of the navigation surfaces (i.e. surfaces with different roughness or reflectivity) despite of no change in the working DOF. The optical navigation device can include the illumination light source used to provide the illumination beam, the illumination lens used to shape the illumination beam, the optical detector having the vertical imaging channel to detect diffuse reflection from the navigation surface, and the imaging lens located on the imaging channel. Position of the illumination lens can be manually adjusted by the user, or can be automatically adjusted by the motorized knob, for changing the beam tilted angle of the illumination beam relative to the navigation surface, and achieve an aim of adjusting or tuning the working range (and/or DOF), the tunable illumination beam angle and/or the cut-off height. The illumination lens can be designed as an optical element separated from the imaging lens, and can be connected with the imaging lens via the mechanical recovery component; or, the illumination lens may be integrated with the imaging lens monolithically via the molded recovery component.

The illumination beam provided by the illumination light source can be a collimated beam, a diverging beam or a converging beam. The imaging channel of the optical detector and the imaging lens can be the vertical imaging channel or the slanted imaging channel. The navigation surface can be a metallic surface, a transparent surface, a translucent surface, an opaque surface, a specular surface, a diffuse surface, a fabric surface, a printed surface, a painted surface, or any surface that can reflect the beam in diffuse or specular modes. Therefore, the optical navigation device can utilize the moving mechanism to change the position of the illumination lens, so as to adjust the projection position of the illumination beam passing through the illumination lens and the related beam tilted angle, and further to provide the tunable DOF for keeping the navigation surface within the working range of the optical navigation device, and/or to provide the tunable cut-off height for a variety of the optical navigation device. The optical navigation device of the present invention can be preferably applied to the embodiment of requesting the optical detector to be tunable for different angles of incidence (or the beam tilted angle) when being applied for different types of the navigation surface (i.e. the surface with different roughness or reflectivity).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical navigation device of analyzing an illumination beam reflected from a navigation surface to execute navigation operation, the optical navigation device comprising:
an illumination light source of emitting the illumination beam;
an illumination lens disposed adjacent to the illumination light source and located on an output path of the illumination beam; and
a moving mechanism connected to the illumination lens and adapted to drive a relative movement between the illumination lens and the illumination light source, so as to adjust a projection position of the illumination beam passing through the illumination lens and further to keep the navigation surface within a working range of the optical navigation device.

2. The optical navigation device of claim 1, wherein the optical navigation device further comprises a case adapted to accommodate the illumination light source, the illumination lens and the moving mechanism, the moving mechanism comprises an adjustment component movably passing through the case and abutting against the illumination lens to generate the relative movement.

3. The optical navigation device of claim 2, wherein the adjustment component is moved relative to the case in a manual manner or in an automatic manner.

4. The optical navigation device of claim 2, wherein the moving mechanism further comprises a recovery component disposed adjacent to the illumination lens and adapted to move the illumination lens back to an initial position.

5. The optical navigation device of claim 2, wherein the optical navigation device further comprises a connection component disposed on the case and attached to the adjustment component, and adapted to drive the adjustment component for the relative movement.

6. The optical navigation device of claim 1, wherein the moving mechanism further comprises a guide track where inside the illumination lens is movably disposed, and the guide track is adapted to constrain a moving direction of the illumination lens.

7. The optical navigation device of claim 4, wherein the recovery component is a compression spring or a tension spring disposed between the illumination lens and an imaging lens of the optical navigation device, or disposed between the illumination lens and the case.

8. The optical navigation device of claim 4, wherein the recovery component is a magnetic assembly, two magnetic components of the magnetic assembly are respectively disposed on the illumination lens and an imaging lens of the optical navigation device, or respectively disposed on the illumination lens and the case.

9. The optical navigation device of claim 4, wherein two opposite ends of the recovery component are respectively connected to the illumination lens and an imaging lens of the optical navigation device, or are integrated with the illumination lens and the imaging lens monolithically.

10. The optical navigation device of claim 1, wherein the optical navigation device further comprises an optical detector adapted to receive the illumination beam reflected from the navigation surface for the navigation operation.

11. The optical navigation device of claim 10, wherein an imaging channel provided by the optical detector is perpendicular to the navigation surface, or a predefined included angle is formed between the imaging channel and the navigation surface.

12. The optical navigation device of claim 11, wherein the moving mechanism drives the relative movement between the illumination lens and the illumination light source to alter a cut-off height of the optical navigation device by changing an edge position of the illumination beam.

13. The optical navigation device of claim 10, wherein the optical navigation device further comprises an imaging lens disposed adjacent to the illumination lens and aligning with the optical detector.

14. The optical navigation device of claim 13, wherein the imaging lens and the illumination lens are two independent units, or are monolithically integrated with each other.

15. The optical navigation device of claim 1, wherein a moving direction of the illumination lens is perpendicular to an output optical axis of the illumination light source.

16. The optical navigation device of claim 11, wherein the moving mechanism drives the relative movement between the illumination lens and the illumination light source to alter a beam tilted angle of the illumination beam relative to the navigation surface for detection of light reflection from different types of the navigation surface.
